(19) United States
(12) Patent Application Publication
(10) Pub. No.: US 2007/0045451 A1
(43) Pub. Date: Mar. 1, 2007

(54) Fuel injection valve

(75) Inventor: Toyoji Nishiwaki, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/495,594

(22) Filed: Jul. 31, 2006

(30) Foreign Application Priority Data
Aug. 31, 2005 (JP) 2005-251790

(51) Int. Cl. F02M 47/02; F02M 63/00; F02M 61/20; F02M 51/00

(52) U.S. Cl. 239/533.2; 239/533.9; 239/88; 239/585.5

(57) ABSTRACT

In a fuel injection valve, a valve member is reciprocable in a longitudinal direction of the valve member to open and close an injection hole. The movable core is reciprocable together with the valve member. The fixed core faces an opposite side of the movable core opposite from the injection hole. The spring applies a force to the valve member in one of reciprocable directions of the valve member. The coil generates a magnetic force to the fixed core when energized such that the fixed core attracts the movable core against the force. The force adjusting member is inserted into the fixed core with a clearance therebetween, wherein the force adjusting member is engaged with the spring. The support member is disposed on an opposite side of the fixed core opposite from the movable core, wherein the force adjusting member is press fitted in the support member.

### CROSS REFERENCE TO RELATED APPLICATION

This application is based on and incorporates herein by reference Japanese Patent Application No. 2005-251790 filed on Aug. 31, 2005.

### BACKGROUND OF THE INVENTION

1. Field of the Invention

The present invention relates to a fuel injection valve.

2. Description of Related Art

For example, Japanese Unexamined Patent Publication 2004-169568 discloses a fuel injection valve, in which a force added to a valve body by a spring is adjusted based on an adjustment of a press-fit position of an adjusting pipe. Here, the valve body opens and closes an injection hole, and the adjusting pipe is engaged with one end of the spring.

An injection quantity by a fuel injection valve 300 shown in FIG. 7, as an example of the above described fuel injection valve, is determined by a static injection quantity and a dynamic injection quantity. Here, the static injection quantity is adjusted based on a lift of a valve member 302. The dynamic injection quantity is adjusted based on the static injection quantity and based on a load (force), which is applied to the valve member 302 by a spring 310.

The lift of the valve member 302 is determined by a gap G between a fixed core 306 and a movable core 304 that is reciprocably displaceable along with the valve member 302. An amount of the load, which is applied to the valve member 302 by the spring 310, is determined by the press-fit position of the adjusting pipe 308, which is engaged with the one end of the spring 310.

However, in the fuel injection valve 300 shown in FIG. 7, there is a fear that the fixed core 306 may be deformed (displaced) in a longitudinal direction when the adjusting pipe 308 is pushed (pressed) into the fixed core 306, because the adjusting pipe 308 is press fitted in the fixed core 306. When the fixed core 306 is deformed in the longitudinal direction, the gap G between the movable core 304 and the fixed core 306 disadvantageously changes.

### SUMMARY OF THE INVENTION

The present invention is made in view of the above disadvantages. Thus, it is an objective of the present invention to address at least one of the above disadvantages.

To achieve the objective of the present invention, there is provided a fuel injection valve, which includes a housing, a valve member, a movable core, a fixed core, a spring, a coil, a force adjusting member and a support member. The housing has an injection hole. The valve member is reciprocably received in the housing, wherein the valve member is reciprocable in a longitudinal direction of the valve member to open and close the injection hole. The movable core is reciprocably received in the housing, wherein the movable core is reciprocable together with the valve member. The fixed core is received in the housing to face an opposite side of the movable core, which is opposite from the injection hole. The spring applies a force to the valve member in one of reciprocable directions of the valve member. The coil generates a magnetic force to the fixed core when the coil is energized such that the fixed core attracts the movable core against the force applied by the spring. The force adjusting member is inserted in an inner periphery of the fixed core with a clearance between the force adjusting member and the fixed core, wherein the force adjusting member is engaged with the spring. The support member is disposed on an opposite side of the fixed core, which is opposite from the movable core, wherein the force adjusting member is press fitted in the support member.

### BRIEF DESCRIPTION OF THE DRAWINGS

The invention, together with additional objectives, features and advantages thereof, will be best understood from the following description, the appended claims and the accompanying drawings in which:

FIG. 1 is a sectional view of a fuel injection valve according to a first embodiment;

FIG. 2A is an enlarged sectional view of an adjusting pipe;

FIG. 2B is a sectional view taken along line IIB-IIB in FIG. 2A;

FIG. 3 is a sectional view of an adjusting pipe having a slit according to a first modification;

FIG. 4 is a sectional view of an adjusting pipe according to a second modification;

FIG. 5 is a sectional view of an adjusting pipe according to a third modification;

FIG. 6 is a sectional view of a fuel injection valve according to a second embodiment; and

FIG. 7 is a sectional view of a fuel injection valve of a related art.

### DETAILED DESCRIPTION OF PREFERRED EMBODIMENTS

### First Embodiment

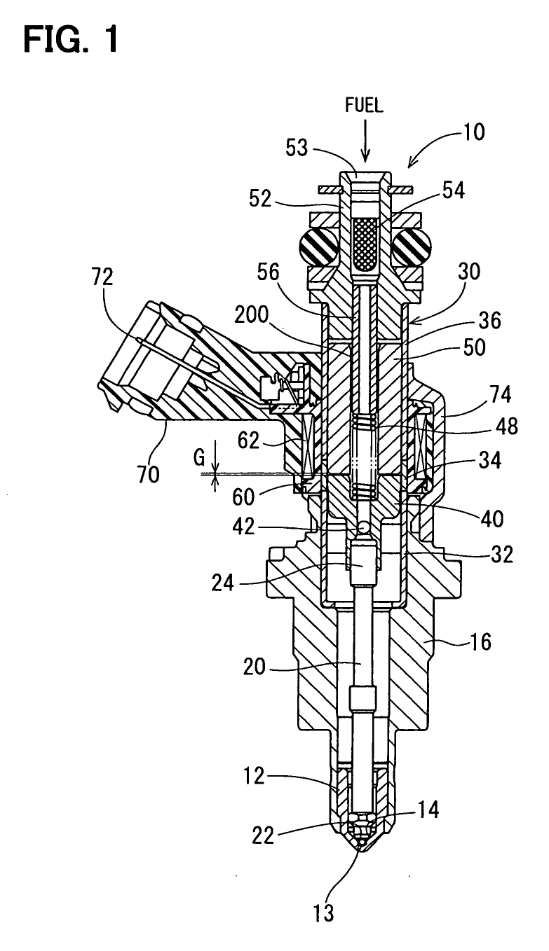

Referring to FIG. 1, a fuel injection valve 10 of a first embodiment is described as an example, in which the present invention is applied to a fuel injection vale for a direct-injection gasoline engine.

A valve body 12 is fixed by a welding to an inner wall of an end portion of a valve housing 16. The valve body 12 includes an injection hole 13 and a valve seat 14. The injection hole 13 is located at an end portion of the valve body 12, and the valve seat 14 is located at an inner surface of the valve body 12 and is upstream of the injection hole 13 in a fuel stream direction.

A nozzle needle 20, which serves as a valve member, includes a contact part 22 for engagement with the valve seat 14 at an end portion of the nozzle needle 20 close to the injection hole 13. The contact part 22 contacts the valve seat 14. When the contact part 22 is engaged with the valve seat 14, fuel injection through the injection hole 13 is terminated. When the contact part 22 is disengaged from the valve seat 14, fuel injection through the injection hole 13 is initiated. The valve seat 14 and the contact part 22 of the nozzle needle 20 constitute a valve, which opens and closes the injection hole 13.

A pipe member 30 is inserted into an inner peripheral wall of the valve housing 16 from an opposite side of the valve housing 16, which is opposite from the valve body 12, and the pipe member 30 is fixed to the valve housing 16 by the welding. Here, the pipe member 30 and the valve housing 16 serve as a housing of the present invention. The pipe member 30 includes a first magnetic member 32, a non-magnetic member 34 for serving as a magnetic resistance member, and a second magnetic member 36, all of which are arranged in this order in a direction away from the injection hole 13. The first magnetic member 32 is magnetically connected with the valve housing 16. A movable core 40 and a fixed core 50 are received in the pipe member 30. The non-magnetic member 34 covers a gap G between the movable core 40 and the fixed core 50 such that the non-magnetic member 34 provides a magnetic short circuit protection between the first magnetic member 32 and the second magnetic member 36. In order to make the pipe member 30, for example, a thin magnetic material may be formed into a cylindrical shape by use of a press. Then, a heat treatment is applied to a certain portion to form the non-magnetic member 34.

The movable core 40 is housed by the pipe member 30 and is fixed by the welding to an opposite end portion 24 of the nozzle needle 20, which is opposite from the injection hole 13, such that the movable core 40 is reciprocably displaceable together with the nozzle needle 20 in a longitudinal direction. The movable core 40 is made of the magnetic material and is formed into a cylindrical shape. The movable core 40 includes a communication bore 42, which extends through the movable core 40 to provide communication between an inside and an outside of the movable core 40. One end of a spring 48, which is also received in the pipe member 30, is engaged with the movable core 40, and another end of the spring 48 is engaged with an adjusting pipe (force adjusting member) 56. The spring 48 applies a force to the nozzle needle 20 toward the valve seat 14 (i.e., the spring 48 biases the nozzle needle 20 in one of reciprocable directions of the nozzle needle 20).

The fixed core 50 is made of the magnetic material and is formed into a cylindrical shape. As shown in FIG. 1, the fixed core 50 is located at an opposite side of the movable core 40, which is opposite from the injection hole 13, and faces the movable core 40. The fixed core 50 is press fitted with an inner peripheral surface of the pipe member 30 at a position such that the gap G between the movable core 40 and the fixed core 50 becomes a predetermined length in a state where the nozzle needle 20 is engaged with the valve seat 14.

An inlet port member 52 serving as a support member is spaced from the fixed core 50 and is located on a opposite side of the fixed core 50, which is opposite from the movable core 40. The inlet port member 52 is press fitted with the inner peripheral surface of the pipe member 30 and is fixed to the pipe member 30 by the welding. The inlet port member 52 includes a filter 54, which removes objects in fuel delivered through a fuel inlet port 53 of the inlet port member 52.

The adjusting pipe 56, which serves as the force adjusting member, is press fitted in the inlet port member 52, and is also inserted in an inner peripheral surface of the fixed core 50 with a clearance 200 formed between the fixed core 50 and the adjusting pipe 56. The load (force) applied by the spring 48 to the movable core 40 and to the nozzle needle 20 is adjusted through the adjustment of a press-fit amount, by which the adjusting pipe 56 is press fitted in the inlet port member 52.

A spool 60 surrounds the pipe member 30 and the coil 62 is wound around an outer periphery of the spool 60. Terminals 72 are insert-molded into a resin housing 70, and is electrically connected with the coil 62. A fuel injection quantity is controlled by adjusting a pulse width of a drive current supplied to the coil 62. A magnetic element 74 covers an outer periphery of the coil 62 and provides magnetic connection between the valve housing 16 and the second magnetic member 36.

Next, an operation of the fuel injection valve 10 will be described. When energization of the coil 62 is turned on, the movable core 40 is attracted toward the fixed core 50 against the load applied by the spring 48 so that the movable core 40 is engaged with the fixed core 50. When the nozzle needle 20 is lifted along with the movable core 40 such that the contact part 22 is disengaged from the valve seat 14, the fuel is injected through the injection hole 13.

When the energization of the coil 62 is turned off, the movable core 40 is separated from the fixed core 50 due to the load applied by the spring 48 such that the contact part 22 of the nozzle needle 20 is engaged with the valve seat 14. This terminates the fuel injection through the injection hole 13.

A static injection quantity by the fuel injection valve 10 is determined by the gap G, which corresponds to a maximum lift of the movable core 40. Also, a dynamic injection quantity by the fuel injection valve 10 is determined by the static injection quantity and the load (force), which is applied by the spring 48 to the movable core 40 and the nozzle needle 20. The load applied by the spring toward the movable core 40 and the nozzle needle 20 is adjusted based on a press-fit position of the adjusting pipe 56, at which the adjusting pipe 56 is press fitted in the inlet port member 52.

In the first embodiment, the adjusting pipe 56 is located upstream of the fixed core 50 in the fuel stream direction (i.e., the adjusting pipe 56 is located on the opposite side of the fixed core 50, which is opposite from the movable core 40). The adjusting pipe 56 is pushed into the inlet port member 52, which is a different member from the fixed core 50, from an opposite side of the inlet port member 52, which is opposite from the fixed core 50. Thus, at the same time that the adjusting pipe 56 is pushed into the inlet port member 52, the adjusting pipe 56 is inserted into the inner periphery of the fixed core 50 with the clearance 200 formed between the adjusting pipe 56 and the fixed core 50. As a result, the adjusting pipe 56 does not contact the fixed core 50 when the press-fit position of the adjusting pipe 56 is adjusted. Thus, a longitudinal position of the fixed core 50 is not changed. Thus, the gap G between the movable core 40 and the fixed core 50 is not changed. Therefore, the injection quantity injected by the fuel injection valve 10 can be precisely adjusted by adjusting the press-fit position of the adjusting pipe 56.

Because the fixed core 50 and the inlet port member 52 are press-fitted in the pipe member 30, this facilitates adjustment of an axis of the fixed core 50 and an axis of the inlet port member 52. As a result, misalignment of the axis of the fixed core 50 and the axis of the adjusting pipe 56, which is press fitted in the inlet port member 52, can be limited. Therefore, the adjusting pipe 56 can be limited from contacting the inner peripheral surface of the fixed core 50 when the adjusting pipe 56 is pushed into the inlet port member 52 so that the adjusting pipe 56 is inserted into the inner periphery of the fixed core 50.

In the present embodiment, the inlet port member 52 serves as the support member, into which the adjusting pipe (force adjusting member) is inserted, of the present invention, the number of the components of the fuel injection valve can be reduced.

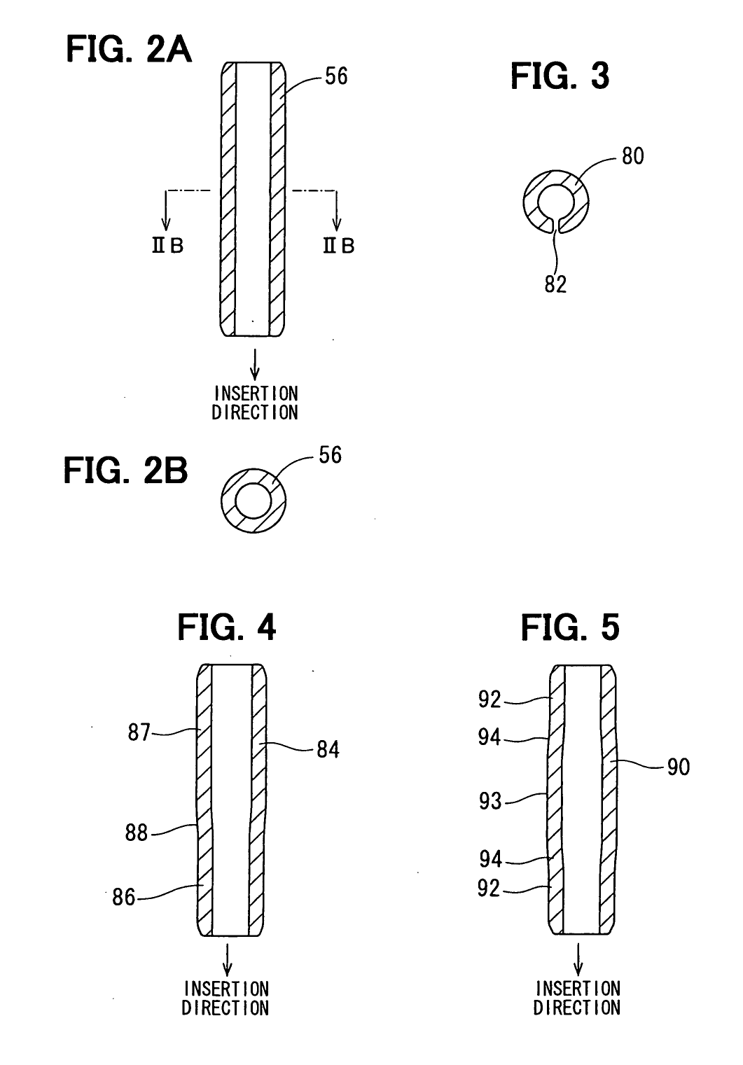

Modifications of the present embodiment will be described. The adjusting pipe 56 shown in FIGS. 2A, 2B may be alternatively replaced with an adjusting pipe 80 of a first modification shown in FIG. 3. The adjusting pipe 80 includes a slit 82, which extends in an axial (longitudinal) direction. Therefore, even in a case where there is a machining error in diameter sizes between an outer diameter of the adjusting pipe 80 and an inner diameter of the inlet port member 52, the adjusting pipe 80 can be elastically deformed to compensate the machining error when the adjusting pipe 80 is pushed into the inlet port member 52.

Also, the adjusting pipe 56 shown in FIGS. 2A, 2B may be alternatively replaced with an adjusting pipe 84 of a second modification shown in FIG. 4. The adjusting pipe 84 includes a minor diameter segment 86, a major diameter segment 87 and a tapered segment 88. Here, the minor diameter segment 86 has an outer diameter smaller than that of the major diameter segment 87. The minor diameter segment 86 is located on an insertion side of the adjusting pipe 84, the insertion side being inserted into the fixed core 50. The major diameter segment 87 is located on an opposite side of the adjusting pipe 84, which is opposite from the insertion side, and the tapered segment 88 is located between the major and minor diameter segments 87, 86. The major diameter segment 87 of the adjusting pipe 84 is press fitted with the pipe member 30 (the inlet port member 52).

Also, the adjusting pipe 56 shown in FIGS. 2A, 2B may be alternatively replaced with an adjusting pipe 90 of a third modification shown in FIG. 5. The adjusting pipe 90 includes minor diameter segments 92, a major diameter segment 93 and tapered segments 94. Here, each of the minor diameter segments 92 has an outer diameter smaller than that of the major diameter segment 93. The minor diameter segments 92 are located on both longitudinal ends of the adjusting pipe 90, and the major diameter segment 93 is located at a center of the adjusting pipe 90. Each of the tapered members 94 is located between the corresponding minor diameter segment 92 and the major diameter segment 93.

In the second and third modification, the minor diameter segment 86, 92 leads the tapered segment 88, 94 and the major diameter segment 87, 93 into the pipe member 30 (the inlet port member 52) when the adjusting pipe 84, 90 is pushed into the pipe member 30 (the inlet port member 52). Thus, the adjusting pipe 84, 90 can be smoothly pushed into the pipe member 30 (the inlet port member 52) because a tilt of the adjusting pipe 84, 90 toward the pipe member 30 (the inlet port member 52) can be controlled due to the above structure of the adjusting pipe 84, 90.

Also, in the third modification, either longitudinal end of the adjusting pipe 90 can be pushed into the pipe member 30 (the inlet port member 52), because the adjusting pipe 90 includes the minor diameter segments 92 on both longitudinal ends thereof. Thus, it is limited that an erroneous end of the adjusting pipe 90 is erroneously directed toward the pipe member 30 (the inlet port member 52) when the adjusting pipe 90 is pushed into the pipe member 30 (the inlet port member 52).

### Second Embodiment

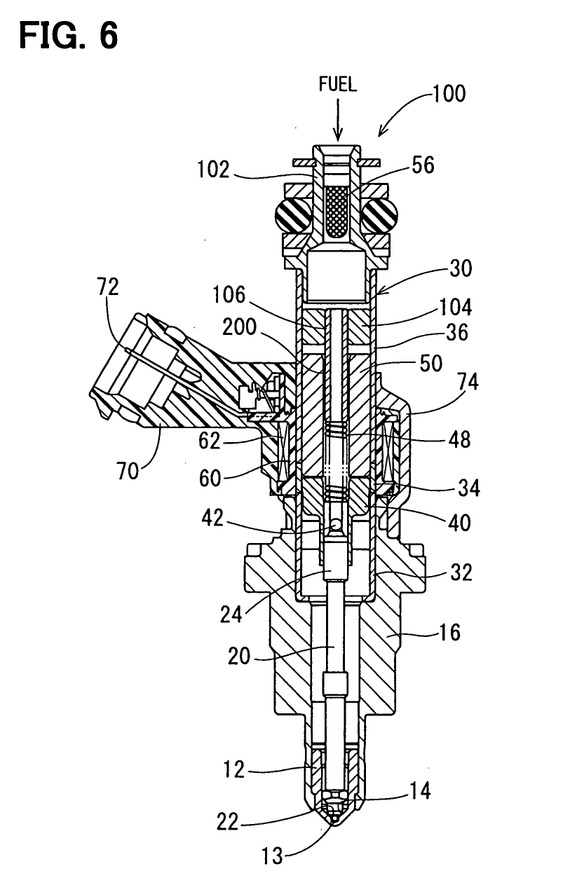

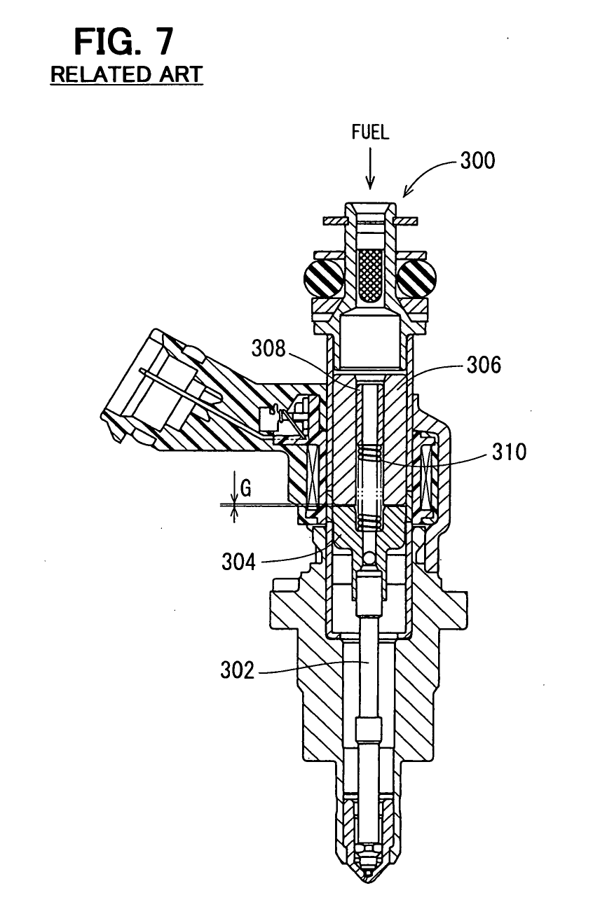

A fuel injection valve 100 according to a second embodiment of the present is shown in FIG. 6. The same numerals are used for corresponding constituent parts, which are substantially the same constituent parts in the first embodiment, and explanations thereof are omitted.

In the second embodiment, an adjusting pipe 106 is press fitted in a cylindrical support member 104 instead of an inlet port member 102, and the adjusting pipe 106 is inserted in the inner periphery of the fixed core 50 with the clearance 200 formed between the adjusting pipe 106 and fixed core 50. Thus, in the second embodiment, the pipe member 30 serves as the support member of the present invention. The support member 104 is press fitted in the pipe member 30 on an opposite side of the fixed core 50, which is opposite from the movable core 40.

### Other Embodiment

In the above multiple embodiments, the fixed core 50 is fixed by the welding to the pipe member 30 after the fixed core 50 is pushed into the pipe member 30. However, the welding of the fixed core 50 to the pipe member 30 may be omitted because the press load (pushing force) by the adjusting pipe is not applied to the fixed core 50.

Also, in the above multiple embodiments, the pipe member 30, which covers the outer peripheries of the movable core 40 and the fixed core 50, includes the first and second magnetic members 32, 36 such that the magnetic resistance of a magnetic flux that passes through the pipe member 30 is reduced. Also, the pipe member 30 includes the non-magnetic member 34 between the first and second magnetic members 32, 36 such that the magnetic short circuit between the first and second magnetic members 32, 36 is limited. However, the entire pipe member 30 may be alternatively made of the non-magnetic material. This is because even in a case, where the pipe member 30 is made of the non-magnetic material, the magnetic flux can substantially pass through the pipe member 30 in a board thickness direction (radial direction) if the board thickness of the pipe member 30 is substantially thin.

In the above multiple embodiments, there is described an example, in which the present invention is applied to the fuel injection valve for the direct-injection gasoline engine. However, the present invention is not limited to this. For example, the present invention may be applied to a fuel injection valve for a diesel engine, or to a fuel injection valve, which injects the fuel into an intake pipe.

Additional advantages and modifications will readily occur to those skilled in the art. The invention in its broader terms is therefore not limited to the specific details, representative apparatus, and illustrative examples shown and described.

What is claimed is:

1. A fuel injection valve, comprising:
a housing that has an injection hole;
a valve member that is reciprocably received in the housing, wherein the valve member is reciprocable in a longitudinal direction of the valve member to open and close the injection hole;
a movable core that is reciprocably received in the housing, wherein the movable core is reciprocable together with the valve member;
a fixed core that is received in the housing to face an opposite side of the movable core, which is opposite from the injection hole;
a spring that applies a force to the valve member in one of reciprocable directions of the valve member;
a coil that generates a magnetic force to the fixed core when the coil is energized such that the fixed core attracts the movable core against the force applied by the spring;
a force adjusting member that is inserted in an inner periphery of the fixed core with a clearance between the force adjusting member and the fixed core, wherein the force adjusting member is engaged with the spring; and
a support member that is disposed on an opposite side of the fixed core, which is opposite from the movable core, wherein the force adjusting member is press fitted in the support member.

2. The fuel injection valve according to claim 1, wherein the housing includes a pipe member, in which the fixed core and the support member are press fitted.

3. The fuel injection valve according to claim 1, wherein the support member includes a fuel inlet port.

4. The fuel injection valve according to claim 1, wherein the force adjusting member includes a slit, which extends in a longitudinal direction of the force adjusting member.

5. The fuel injection valve according to claim 1, wherein:
the force adjusting member includes:
a minor diameter segment that is located on one longitudinal end portion of the force adjusting member; and
a major diameter segment that has an outer diameter larger than that of the minor diameter segment and is located on another longitudinal end portion of the force adjusting member, which is opposite from the one longitudinal end portion; and
the major diameter segment of the force adjusting member is press fitted in the support member.

6. The fuel injection valve according to claim 1, wherein:
the force adjusting member includes:
first and second minor diameter segments, each of which is located on a corresponding one of both longitudinal end portions of the force adjusting member; and
a major diameter segment that has an outer diameter larger than that of each of the first and second minor diameter segments; and
the major diameter segment of the force adjusting member is press fitted in the support member.
